(19) United States
(12) Patent Application Publication
(10) Pub. No.: US 2025/0385039 A1
(43) Pub. Date: Dec. 18, 2025

(54) COIL COMPONENT

(71) Applicant: TAIYO YUDEN CO., LTD., Tokyo (JP)

(72) Inventor: Hirotaka WAKABAYASHI, Tokyo (JP)

(21) Appl. No.: 19/233,864

(22) Filed: Jun. 10, 2025

(30) Foreign Application Priority Data
Jun. 13, 2024 (JP) 2024-096248

(51) Int. Cl. H01F 27/29; H01F 27/28

(52) U.S. Cl. CPC H01F 27/292; H01F 27/2852

(57) ABSTRACT

The invention increases the adhesion strength between external electrodes and a base body. A coil component according to one aspect includes: a base body having a first surface; a coil conductor provided in the base body; and a first and second external electrodes provided on the first surface and spaced apart from each other in a first direction along the first surface. The coil conductor includes a winding portion and a first connecting portion connecting one end of the winding portion to the first external electrode. The first connecting portion extends along a second direction orthogonal to the first direction. The first connecting portion has a first section along a cutting plane orthogonal to the second direction, and a dimension of the first section in a third direction orthogonal to the first direction is larger than a dimension of the first section in the first direction.

### CROSS-REFERENCE TO RELATED APPLICATIONS

This application is based on and claims the benefit of priority from Japanese Patent Application Serial No. 2024-096248 (filed on Jun. 13, 2024), the contents of which are hereby incorporated by reference in their entirety.

### TECHNICAL FIELD

The present disclosure relates mainly to a coil component.

### BACKGROUND

Coil components are installed in various electronic devices. For example, coil components are used to eliminate noise in power source lines or signal lines in circuits. Coil components include a base body made of a magnetic material, a coil conductor provided in the base body, a first external electrode connected to one end of the coil conductor, and a second external electrode connected to the other end of the coil conductor.

To downsize coil components, the first and second external electrodes are sometimes mounted on only a single surface (mounting surface) of the base body. For example, Japanese Patent Application Publication No. 2018-101732 discloses an inductor with external electrodes 13, 13 mounted only on the mounting surface of the base body.

External electrodes mounted only on the mounting surface of the base body are easily removed off the base body due to a small adhesion strength to the base body. In coil components with external electrodes provided only on the mounting surface of the base body, impacts applied to the external electrodes tend to concentrate on the region of the base body near the mounting surface on which the external electrodes are provided, and thus cracks tend to occur in the region near the mounting surface of the base body.

### SUMMARY

It is an object of the present disclosure to solve or alleviate at least part of the drawback mentioned above. One of the more particular objects of the disclosure is to increase the adhesion strength between external electrodes and a base body in a coil component. One of the further particular objects of the disclosure is to increase the adhesion strength between external electrodes and a base body in a coil component having the external electrodes mounted on only one surface of the base body. One of the more particular objects of the disclosure is to increase the strength of a base body in a coil component, at a portion near a mounting surface on which external electrodes are mounted.

Other objects of the present disclosure will be made apparent through the entire description in the specification. The inventions recited in the claims may also address any other drawbacks in addition to the above drawback. The various inventions disclosed herein may be collectively referred to as “the invention”.

A coil component according to one aspect of the invention includes: a base body having a first surface; a coil conductor provided in the base body, the coil conductor being made of a conductive material; a first external electrode provided on the first surface of the base body; and a second external electrode provided on the first surface of the base body. The second external electrode is spaced apart from the first external electrode in a first direction extending along the first surface. The coil conductor includes a winding portion extending along a circumferential direction around a coil axis, a first connecting portion connecting between one end of the winding portion and the first external electrode, and a second connecting portion connecting between another end of the winding portion and the second external electrode. When viewed from a direction perpendicular to the first surface, the first connecting portion extends along a second direction orthogonal to the first direction. The first connecting portion has a first section along a cutting plane orthogonal to the second direction, and a dimension of the first section in a third direction orthogonal to the first direction is larger than a dimension of the first section in the first direction.

### Advantageous Effects

The invention increases the adhesion strength between external electrodes and a base body.

### BRIEF DESCRIPTION OF THE DRAWINGS

FIG. 1 is a perspective view schematically showing a coil component 1 according to one embodiment of the present invention.

FIG. 2 is a schematic sectional view of the coil component 1 along the line I-I.

FIG. 3 is a side view of the coil component 1.

FIG. 4 is a bottom view of the coil component 1.

FIG. 5 is an enlarged sectional view schematically showing, on an enlarged scale, a part of the section shown in FIG. 2 near a first external electrode.

FIG. 6A is an enlarged bottom view schematically showing, on an enlarged scale, a part of the bottom surface of the base body shown in FIG. 4 near the first external electrode.

FIG. 6B is an enlarged bottom view schematically showing, on an enlarged scale, a part of the bottom surface of the base body shown in FIG. 4 near the second external electrode.

FIG. 7A is a schematic enlarged bottom view for explaining the dimensions of the first external electrode and the first connecting portion.

FIG. 7B is a schematic enlarged bottom view for explaining the dimensions of the second external electrode and the second connecting portion.

FIG. 8A schematically illustrates some of the steps of the process of manufacturing the coil component 1.

FIG. 8B schematically illustrates some of the steps of the process of manufacturing the coil component 1.

FIG. 8C (a) schematically illustrates some of the steps of the process of manufacturing the coil component 1.

FIG. 8C (b) schematically illustrates some of the steps of the process of manufacturing the coil component 1.

FIG. 8D schematically illustrates some of the steps of the process of manufacturing the coil component 1.

FIG. 8E schematically illustrates some of the steps of the process of manufacturing the coil component 1.

FIG. 9 is a bottom view schematically showing a coil component 101 according to another embodiment of the present invention.

FIG. 10 is a bottom view schematically showing a coil component 201 according to yet another embodiment of the present invention.

### DESCRIPTION OF THE PREFERRED EMBODIMENTS

Various embodiments of the disclosure will be described hereinafter with reference to the appended drawings. Throughout the drawings, the same components are denoted by the same reference numerals. For convenience of explanation, the drawings are not necessarily drawn to scale. The following embodiments of the present invention do not limit the scope of the claims. The elements included in the following embodiments are not necessarily essential to solve the problem addressed by the invention.

The present invention relates to a coil component. The invention may be applied to inductors, transformers, filters, reactors, and various other coil components. The invention may be also applied to coupled inductors, choke coils, and any other magnetically coupled coil components. Applications of the coil component described herein are not limited to those explicitly described herein.

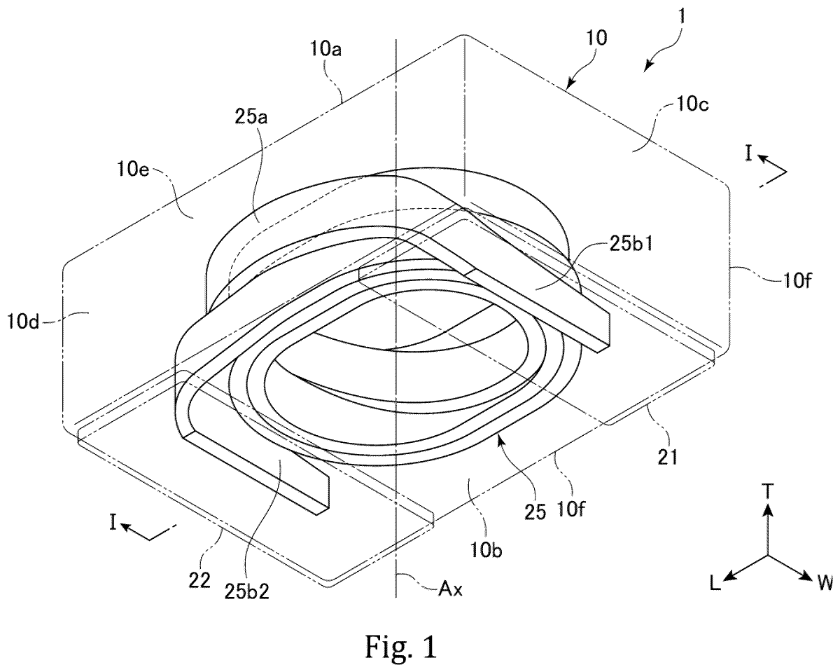

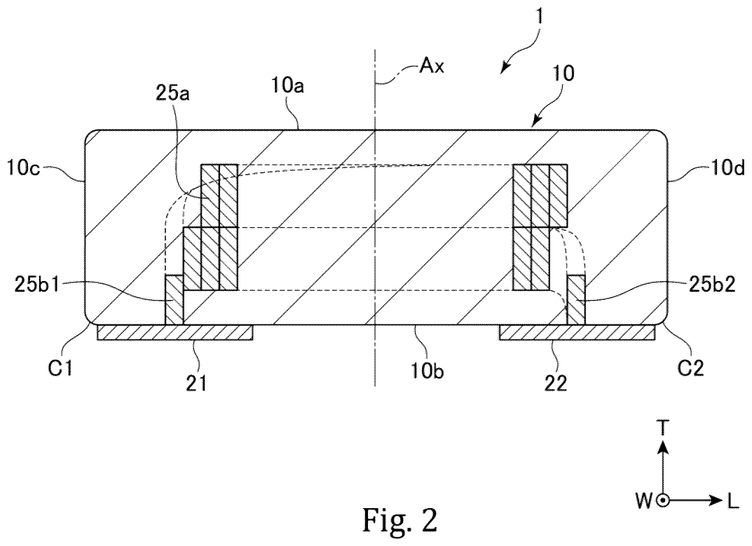

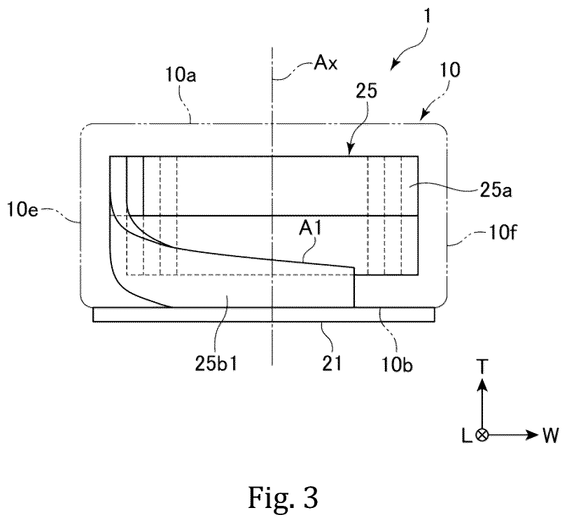

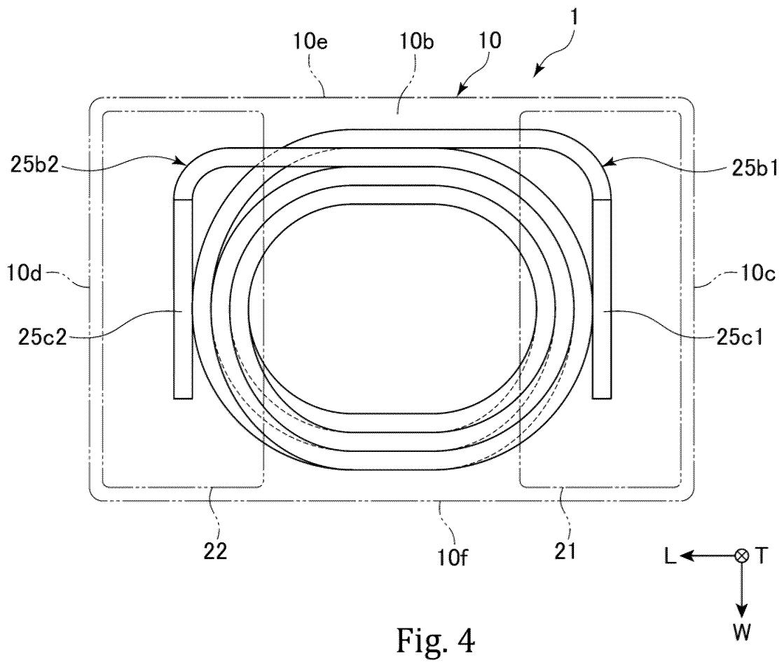

A coil component 1 according to one embodiment of the present invention will be hereinafter outlined with reference to FIGS. 1 to 4. FIG. 1 is a perspective view schematically showing the coil component 1. FIG. 2 is a schematic sectional view of the coil component 1 along the line I-I shown in FIG. 1. FIG. 3 is a side view of the coil component 1. FIG. 4 is a bottom view of the coil component 1.

As shown in FIGS. 1 to 4, the coil component 1 includes a base body 10 having an insulation property, a coil conductor 25 provided in the base body 10, a first external electrode 21 disposed on a surface of the base body 10, and a second external electrode 22 disposed on the surface of the base body 10 at a position spaced apart from the first external electrode 21. The coil conductor 25 is provided within the base body 10. For the sake of convenience, FIGS. 1 and 4 show the coil conductor 25 through the base body 10 and the first and second external electrodes 21 and 22. Also, FIG. 3 show the coil conductor 25 through the base body 10.

The arrangement, dimensions, shapes, and other aspects of the members may be herein described based on the “L axis”, the “W axis”, and the “T axis” shown in the drawings. The direction along the L axis may be referred to as the L-axis direction, the direction along the W axis as the W-axis direction, and the direction along the Taxis as the T-axis direction. The L axis, the W axis, and the Taxis are perpendicular to each other.

The coil component 1 may be mounted on a mounting substrate. The mounting substrate has land portions. The coil component 1 is mounted on the mounting substrate by connecting the first external electrode 21 and the second external electrode 22 to the land portions of the mounting substrate. The mounting substrate having the coil component 1 mounted thereon may be installed in smartphones, tablets, game consoles, electrical components of automobiles, servers, and various other electronic devices.

The base body 10 is made of a magnetic material. The base body 10 is formed in a substantially rectangular parallelepiped shape. In one embodiment of the present invention, the base body 10 is configured such that the dimension in the L-axis direction (length dimension) is greater than the dimension in the W-axis direction (width dimension) and the dimension in the T-axis direction (height dimension). For example, the coil component 1 has a length dimension of 1.0 mm to 6.0 mm, a width dimension of 0.5 mm to 4.5 mm, and a height dimension of 0.5 mm to 4.5 mm. The dimensions of the base body 10 are not limited to those specified herein. The term “rectangular parallelepiped” or “rectangular parallelepiped shape” used herein is not intended to mean solely “rectangular parallelepiped” in a mathematically strict sense. The dimensions and the shape of the base body 10 are not limited to those specified herein.

The base body 10 has a top surface 10a, a bottom surface 10b, a first end surface 10c, a second end surface 10d, a first side surface 10e, and a second side surface 10f. The outer surface of the base body 10 is defined by these six surfaces. The top surface 10a and the bottom surface 10b are at the opposite ends of the base body 10 in the height direction, the first end surface 10c and the second end surface 10d are at the opposite ends of the base body 10 in the width direction, and the first side surface 10e and the second side surface 10f are at the opposite ends of the base body 10 in the length direction.

In the coil component 1, both the first external electrode 21 and the second external electrode 22 are disposed on the bottom surface 10b of the base body 10. The bottom surface 10b extends along the L-axis direction and the W-axis direction. In other words, the bottom surface 10b extends along the LW plane. The first external electrode 21 and the second external electrode 22 are disposed on the bottom surface 10b of the base body 10 so as to be spaced apart from each other in the L-axis direction. In the illustrated embodiment, the first and second external electrodes 21 and 22 are both in contact with only the bottom surface 10b of the base body 10 and in contact with none of the surfaces other than the bottom surface 10b. The bottom surface 10b of the base body 10 may be connected to the first end surface 10c via a curved portion C1. Also, the bottom surface 10b of the base body 10 may be connected to the second end surface 10d via a curved portion C2. The first external electrode 21 may extend from the bottom surface 10b to the curved portion C1. The second external electrode 22 may extend from the bottom surface 10b to the curved portion C2. Since the coil component 1 is disposed such that the bottom surface 10b faces the mounting substrate, the bottom surface 10b may be herein referred to as “the mounting surface.” The bottom surface 10b of the base body 10 is an example of the “first surface” of the base body recited in the claims.

The first and second external electrodes 21 and 22 may each include a base electrode layer and a plating layer formed on the surface of the base electrode layer. The plating layer is formed by the electrolytic plating method, for example. The base electrode layer is formed by, for example, applying a conductive paste to the surface of the base body 10. The conductive paste contains conductive materials having excellent conductivity such as Cu, Ag, Pd, Ni or alloys of these metals. The base electrode layer may be formed on the surface of the base body 10 by plating, for example. In the case where the base electrode layer is a plating layer, it can be formed by the electrolytic plating method, for example. Two or more plating layers may be formed on the surface of the base electrode layer. The two or more plating layers may include a Ni plating layer and a Sn plating layer externally provided on the Ni plating layer. The two or more plating layers may further include at least one of an Au plating layer and a Pd plating layer.

Each of the first and second external electrodes 21 and 22 can have a thickness (dimension in the T-axis direction) of 5 to 30 μm. In the case where each of the first and second external electrodes 21 and 22 has a base electrode layer and a plating layer, the thickness of the base electrode layer can be 3 to 20 μm, and the thickness of the plating layer (or the total thickness of two or more plating layers) can be 10 μm or less. The thickness of the first external electrode 21 may be uniform. The first external electrode 21 may be formed so that its thickness in the region near the first end surface 10c is larger than in other regions. The thickness of the second external electrode 22 may be uniform. The second external electrode 22 may be formed so that its thickness in the region near the second end surface 10d is larger than in other regions.

In one embodiment of the present invention, the base body 10 is formed of a magnetic material. The magnetic material used for the base body 10 may be, for example, ferrites, soft magnetic alloy materials, or magnetic mixture materials obtained by mixing these.

The ferrites used for the base body 10 include a Ni—Cu—Zn-based ferrite, a Ni—Cu—Zn—Mg-based ferrite, a Cu—Zn-based ferrite, an Ni—Cu-based ferrite, or any other known ferrites.

The soft magnetic metal material for the base body 10 contains at least one metal element among Fe, Ni, and Co. The soft magnetic metal materials used for the base body 10 are, for example, (1) metals such as Fe or Ni; (2) alloys such as Fe—Si—Cr, Fe—Si—Al, Fe—Ni, Fe—Co, or Fe—Si—B—Nb—Cu; (3) amorphous materials Fe—Si—Cr—B—C or Fe—Si—Cr—B; or (4) a mixture material of these. The base body 10 may be composed of a plurality of metal magnetic particles made of a soft magnetic metal material.

The metal magnetic particles contained in the base body 10 have a spherical or elliptical section or a section deformed therefrom. The average particle size of the metal magnetic particles contained in the base body 10 can be 2 to 10 μm. The average particle size of the metal magnetic particles contained in the base body 10 can be determined, for example, as follows. First, the base body 10 is cut or ground along its thickness direction (the T-axis direction) to expose a sectional surface. The sectional surface is photographed using a scanning electron microscope (SEM) to obtain a SEM image at a magnification of about 10,000 to 50,000. Next, the equivalent circle diameter (Haywood diameter) of each metal magnetic particle is determined in the SEM image by image analysis. The average value of the equivalent circle diameters of the metal magnetic particles in the SEM image can then be taken as the average particle size of the metal magnetic particles.

Adjacent ones of the metal magnetic particles in the base body 10 may be bound together via an insulating film. The insulating film may contain an oxide of the element constituting the metal magnetic particles. An insulating oxide film may be formed on the surface of each of the metal magnetic particles, and adjacent ones of the metal magnetic particles may be bound together by the oxide film.

The base body 10 may contain a resin. In the base body 10, the metal magnetic particles may be bound together by a resin binder. The binder is composed of, for example, thermosetting resin having a good insulation property. The resin material used as the binder has a smaller magnetic permeability than the first magnetic material. Examples of the resin material for the binder include an epoxy resin, a polyimide resin, a polystyrene (PS) resin, a high-density polyethylene (HDPE) resin, a polyoxymethylene (POM) resin, a polycarbonate (PC) resin, a polyvinylidene fluoride (PVDF) resin, a phenolic resin, a polytetrafluoroethylene (PTFE) resin, or a polybenzoxazole (PBO) resin, and resins modified from these.

When the metal magnetic particles are bound together by a binder in the base body 10, the proportion of the metal magnetic particles in the base body 10 should preferably be 90 vol % or larger. The proportion of the binder in the base body may be 3 vol % or smaller, or 2 vol % or smaller.

The coil conductor 25 includes a winding portion 25a extending along the circumferential direction around the coil axis Ax, a first connecting portion 25b1 extending from one end of the winding portion 25a to the first external electrode 21, and a second connecting portion 25b2 extending from the other end of the winding portion 25a to the second external electrode 22. The coil conductor 25 may be formed by plastic deformation of a strip made of a conductive material. For example, the coil conductor 25 may be formed by winding the strip around a core using a commercially available winding machine.

The coil conductor 25 is made of a material having excellent conductivity, such as Cu, Ag, or Ni. The surface of the coil conductor 25 may be covered by an insulating film. The insulating film may be composed of a thermosetting resin having a good insulation property, such as polyurethane, polyamide imide, or phenol. The insulating film may be composed of an oxide of the metal element contained in the coil conductor 25.

The winding portion 25a is wound around the coil axis Ax for a plurality of turns. The number of turns of the winding portion 25a may be six or smaller. The number of turns of the winding portion 25a may be four or smaller. The winding portion 25a may be wound around the coil axis Ax for a number of turns other than those explicitly described herein. The coil axis Ax is an imaginary axis extending orthogonally to the bottom surface 10b. The coil axis Ax may extend through the geometric center of the bottom surface 10b in bottom view. In the illustrated embodiment, the winding portion 25a includes two layers in the T-axis direction.

As clearly shown in FIG. 3, the first connecting portion 25b1 extends from one end of the winding portion 25a to the first external electrode 21 in a direction inclined with respect to the coil axis Ax and the bottom surface 10b. In one aspect, the inclination of the first connecting portion 25b1 with respect to the bottom surface 10b is 1 to 10°. To ensure a reasonable size of a first connecting end surface 25c1 (described later), the inclination of the first connecting portion 25b1 with respect to the bottom surface 10b should preferably be 1 to 5°. The inclination of the first connecting portion 25b1 with respect to the bottom surface 10b can be expressed as the angle between the upper side A1 of the first connecting portion 25b1 and the bottom surface 10b. As shown in FIG. 4, in the bottom view, the first connecting portion 25b1 extends along the W-axis direction.

In conventional coil components, a winding portion and an external electrode are connected by a connecting conductor that extends along the T-axis direction. By contrast, in the coil component 1, the first connecting portion 25b1 extends in a direction inclined with respect to the coil axis Ax and the bottom surface 10b, which allows a larger contact area between the first connecting portion 25b1 and the base body 10 compared to the conventional connection structure. Therefore, in the illustrated embodiment, the adhesion strength between the first connecting portion 25b1 and the base body 10 can be increased compared to the conventional connection structure. In addition, since both the first connecting portion 25b1 and the first external electrode 21 are made of a conductive material (typically a metal or an alloy), the first external electrode 21 and the first connecting portion 25b1 are firmly bonded together. Therefore, the increased adhesion strength between the first connecting portion 25b1 and the base body 10 results in an increased adhesion strength of the first external electrode 21 to the base body 10. This inhibits the first external electrode 21 from being removed off the base body 10.

The second connecting portion 25b2 extends from the other end of the winding portion 25a to the second external electrode 22 in a direction inclined with respect to the coil axis Ax and the bottom surface 10b. In one aspect, the inclination of the second connecting portion 25b2 with respect to the bottom surface 10b is 1 to 10°. To ensure a reasonable size of a second connecting end surface 25c2 (described later), the inclination of the second connecting portion 25b2 with respect to the bottom surface 10b should preferably be 1 to 5°. Since the second connecting portion 25b extends in a direction inclined with respect to the bottom surface 10b, the adhesion strength between the second connecting portion 25b2 and the base body 10 can be increased for the same reason as for the increased adhesion strength between the first connecting portion 25b1 and the base body 10. The increased adhesion strength between the second connecting portion 25b2 and the base body 10 results in an increased adhesion strength of the second external electrode 22 to the base body 10. This inhibits the second external electrode 22 from being removed off the base body 10.

In coil component 1, the first connecting portion 25b1 extends from one end of the winding portion 25a at a slight inclination (e.g., about 1 to 10°) with respect to the bottom surface 10b of the base body 10, so that it serves as a beam to withstand loads applied to the base body 10. The second connecting portion 25b2 extends from the other end of the winding portion 25a at a slight inclination (e.g., about 1 to 10°) with respect to the bottom surface 10b of the base body 10, so it serves as a beam to withstand loads applied to the base body 10. The first connecting portion 25b1, which is connected to the first external electrode 21, can withstand loads applied to the base body 10, particularly through the first external electrode 21. The second connecting portion 25b2, which is connected to the second external electrode 22, can withstand loads applied to the base body 10, particularly through the second external electrode 22. Since the loads applied to the base body 10 are withstood by the first and second connecting portions 25b1 and 25b2, the mechanical strength of the base body 10 can be maintained to such a degree that it does not interfere with practical use, even with a small proportion of the binder at 3 vol % or smaller, as described above.

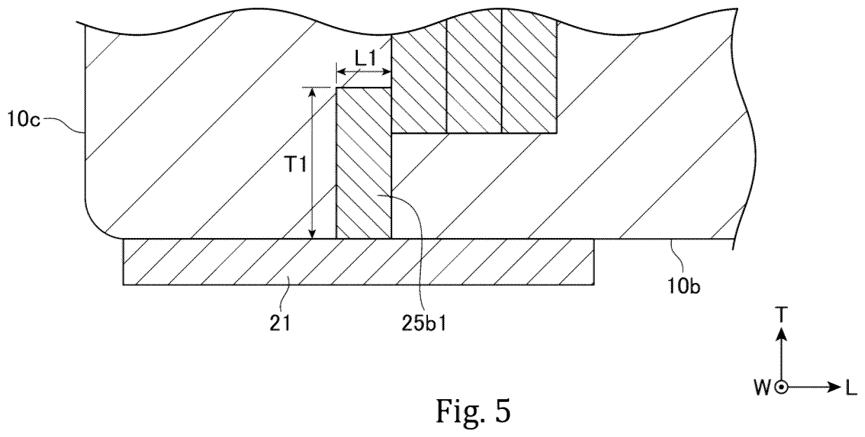

With further reference to FIG. 5, the first connecting portion 25b1 and the second connecting portion 25b2 will be further described. FIG. 5 is an enlarged sectional view showing, on an enlarged scale, a part of the section shown in FIG. 2 near the first connecting portion 25b1.

FIG. 5 shows, on an enlarged scale, a section of the first connecting portion 25b1 cut along a plane perpendicular to the W-axis direction. In one aspect, the section of the first connecting portion 25b1 has a rectangular shape. The dimension of the section of the first connecting portion 25b1 in the T-axis direction is T1, and the dimension of the same section in the L-axis direction is L1. As illustrated, the first connecting portion 25b1 is configured and arranged so that the dimension T1 in the T-axis direction of the section along the cutting plane orthogonal to the W-axis direction is larger than the dimension L1 in the L-axis direction of the same section. Although FIG. 5 shows a section near the center in the W-axis direction, the first connecting portion 25b1 may be configured so that the dimension in the T-axis direction is larger than the dimension in the L-axis direction in a section at any position in the W-axis direction.

The first connecting portion 25b 1 is firmly connected to the first external electrode 21 provided on the bottom surface 10b, and is embedded from the bottom surface 10b into the base body 10 to a depth corresponding to the dimension T1. Therefore, the first external electrode 21 provided on the bottom surface 10b is fixed to the base body 10 by the first connecting portion 25b1, which is embedded from the bottom surface 10b into the base body 10 to a depth corresponding to the dimension T1. Therefore, with the dimension T1 larger than the dimension L1, the first external electrode 21 can be more firmly adhered to the base body 10. In addition, the first connecting portion 25b1 can block the transmission of impacts applied to the base body 10 through the first external electrode 21. With the dimension T1 larger than the dimension L1, the transmission of impacts applied to the base body 10 through the first external electrode 21 can be further inhibited.

Although not shown, the section of the second connecting portion 25b2 is configured in the same manner as the section of the first connecting portion 25b1. Specifically, the dimension in the T-axis direction of the section of the second connecting portion 25b2 along the cutting plane orthogonal to the W-axis direction is larger than the dimension in the L-axis direction of the same section. Thus, the second external electrode 22 can be more firmly adhered to the base body 10. In addition, the second connecting portion 25b2 can inhibit the transmission of impacts applied to the base body 10 through the second external electrode 22.

The first connecting portion 25b1 extends from one end of the winding portion 25a in a direction inclined with respect to the coil axis Ax and the bottom surface 10b so that the first connecting end surface 25c1 is exposed from the bottom surface 10b to the outside of the base body 10. Since the angle between the extension direction of the first connecting portion 25b1 and the bottom surface 10b is as small as, e.g., 10° or smaller, the first connecting end surface 25c1 has an elongated shape extending in the W-axis direction in the bottom view, as shown in FIG. 4. In conventional coil components, a winding portion and an external electrode are connected by a connecting conductor that extends along the T-axis direction, and therefore, the area of the end surface of the connecting conductor exposed from the base body is equal to the sectional area of the strip constituting the coil conductor. By contrast, in the illustrated embodiment of the invention, the first connecting portion 25b 1 extends at an angle to the coil axis Ax, so that the first area, which represents the area of the first connecting end surface 25c1 exposed from the bottom surface 10b, is larger than the second area, which represents the sectional area of the strip constituting the coil conductor 25. Therefore, in an aspect of the present invention, the first connecting portion 25b1 is connected to the first external electrode 21 at the first connecting end surface 25c1, which has a larger area than the section of the strip constituting the coil conductor 25. Thus, in one aspect of the present invention, the bonding strength between the first connecting portion 25b1 and the first external electrode 21 can be improved by increasing the contact area between the first connecting portion 25b1 and the first external electrode 21.

The second connecting portion 25b2 extends from the other end of the winding portion 25a in a direction inclined with respect to the coil axis Ax and the bottom surface 10b so that the second connecting end surface 25c2 is exposed from the bottom surface 10b to the outside of the base body 10. As with the first connecting end surface 25c1, the second connecting end surface 25c2 has an elongated shape extending in the W-axis direction in the bottom view. As with the first connecting portion 25b1, the second connecting portion 25b2 extends at an angle to the coil axis Ax, so that the area of the second connecting end surface 25c2 exposed from the bottom surface 10b is larger than the sectional area of the strip constituting the coil conductor 25. Therefore, in an aspect of the present invention, the second connecting portion 25b2 is connected to the second external electrode 22 at the second connecting end surface 25c2, which has a larger area than the section of the strip constituting the coil conductor 25. Thus, in one aspect of the present invention, the bonding strength between the second connecting portion 25b2 and the second external electrode 22 can be improved by increasing the contact area between the second connecting portion 25b2 and the second external electrode 22.

To increase the bonding strength between the first connecting portion 25b1 and the first external electrode 21, the area of the first connecting end surface 25c1 of the first connecting portion 25b1 should preferably be two or more times the sectional area of the strip. It is further preferable that the area of the first connecting end surface 25c1 of the first connecting portion 25b1 be four or more times the sectional area of the strip. Similarly, to increase the bonding strength between the second connecting portion 25b2 and the second external electrode 22, the area of the second connecting end surface 25c2 of the second connecting portion 25b2 should preferably be two or more times the sectional area of the strip. It is further preferable that the area of the second connecting end surface 25c2 of the second connecting portion 25b2 be four or more times the sectional area of the strip.

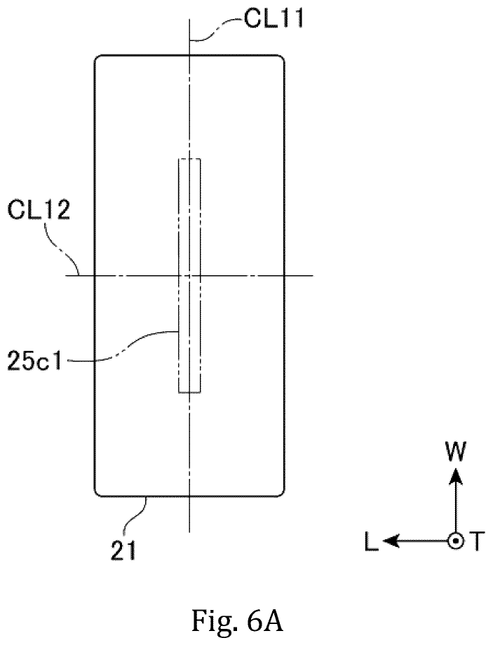

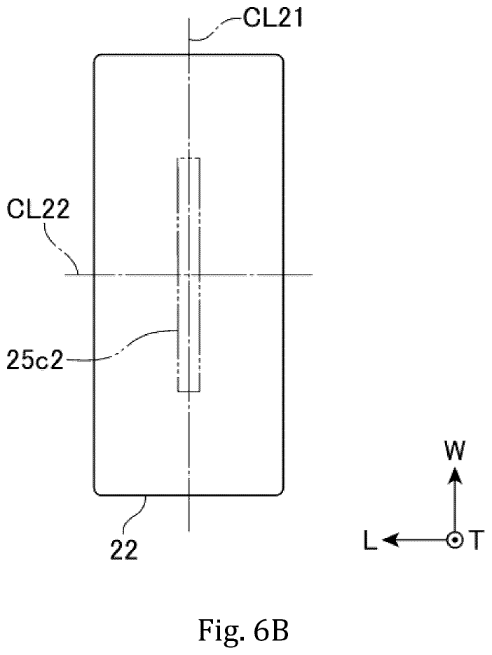

With further reference to FIGS. 6A and 6B, a further description is given of the location of the first connecting end surface 25c1 relative to the first external electrode 21 and the location of the second connecting end surface 25c2 relative to the second external electrode 22. FIG. 6A is a schematic enlarged bottom view of the bottom surface 10b of the base body 10 shown in FIG. 4, showing a part near the first external electrode 21, and FIG. 6B is a schematic enlarged bottom view of the bottom surface 10b of the base body 10 shown in FIG. 4, showing a part near the second external electrode 22.

As shown in FIG. 6A, the first connecting end surface 25c1 is located near the center of the first external electrode 21. More specifically, the first connecting end surface 25c1 extends in the L-axis direction to intersect the first center line CL11 passing through the center of the first external electrode 21 in the L-axis direction. In other words, the first connecting end surface 25c1 extends in the L-axis direction from a position on the positive side of the first center line CL11 in the L-axis direction to a position on the negative side of the first center line CL11 in the L-axis direction. The first connecting end surface 25c1 also extends in the W-axis direction to intersect the second center line CL12 passing through the center of the first external electrode 21 in the W-axis direction. In other words, the first connecting end surface 25c1 extends in the W-axis direction from a position on the positive side of the second center line CL12 in the W-axis direction to a position on the negative side of the second center line CL12 in the W-axis direction. The first connecting end surface 25c1 may intersect both the first center line CL11 and the second center line CL12, as shown in FIG. 6A. The first connecting end surface 25c1 may be located to overlap the geometric center of the first external electrode 21 in the bottom view (i.e., in the perspective from the T-axis direction).

As shown in FIG. 6B, the second connecting end surface 25c2 is located near the center of the second external electrode 22. The location of the second connecting end surface 25c2 relative to the second external electrode 22 may be the same as the location of the first connecting end surface 25c1 relative to the first external electrode 21. More specifically, the second connecting end surface 25c2 extends in the L-axis direction to intersect the third center line CL21 passing through the center of the second external electrode 22 in the L-axis direction. The second connecting end surface 25c2 also extends in the W-axis direction to intersect the fourth center line CL22 passing through the center of the second external electrode 22 in the W-axis direction. The second connecting end surface 25c2 may intersect both the third center line CL21 and the fourth center line CL22, as shown in FIG. 6B. The second connecting end surface 25c2 may be located to overlap the geometric center of the second external electrode 22 in the bottom view (i.e., in the perspective from the T-axis direction).

Since the first connecting end surface 25c1 of the first connecting portion 25b 1 is located near the center of the first external electrode 21, the base body 10 can support the central part of the first external electrode 21 by the first connecting portion 25b1 embedded in the base body 10, thus further improving the adhesion strength of the first external electrode 21 to the base body 10. Similarly, since the second connecting end surface 25c2 of the second connecting portion 25b2 is located near the center of the second external electrode 22, the base body 10 can support the central part of the second external electrode 22 by the second connecting portion 25b2 embedded in the base body 10, thus further improving the adhesion strength of the second external electrode 22 to the base body 10.

In addition, since the first connecting end surface 25c1 of the first connecting portion 25b1 is located near the center of the first external electrode 21, the first connecting portion 25b1 can block the impacts applied to the first external electrode 21 from various directions in the LW plane from being transmitted within the base body 10. Similarly, since the second connecting end surface 25cc of the second connecting portion 25b2 is located near the center of the second external electrode 22, the second connecting portion 25b2 can block the impacts applied to the second external electrode 22 from various directions in the LW plane from being transmitted within the base body 10. This can inhibit the impacts applied from the outside to the base body 10 through the first external electrode 21 or the second external electrode 22 from being transmitted to the inside of the base body 10.

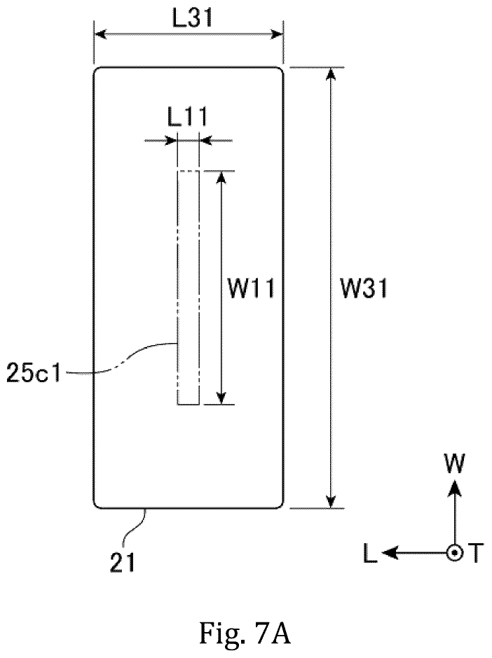

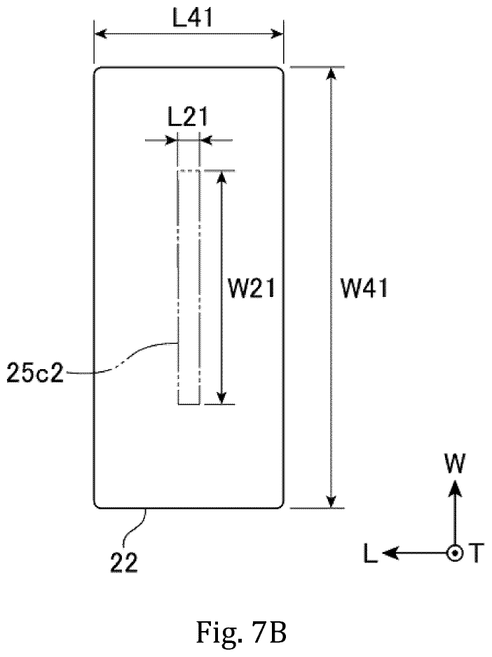

With further reference to FIGS. 7A and 7B, a further description is given of the dimensions of the first and second connecting end surfaces 25c1 and 25c2 and the first and second external electrodes 21 and 22. FIG. 7A is a schematic enlarged bottom view of the bottom surface of the base body 10 shown in FIG. 4, showing a part near the first external electrode 21, and FIG. 7B is a schematic enlarged bottom view of the bottom surface of the base body 10 shown in FIG. 4, showing a part near the second external electrode 22. FIGS. 7A and 7B differ from FIGS. 6A and 6B in that signs are shown to indicate dimensions.

As shown in FIG. 7A, the dimension L11 in the L-axis direction of the first connecting end surface 25c1 is smaller than the dimension W11 in the W-axis direction of the first connecting end surface 25c1. The dimension L31 in the L-axis direction of the first external electrode 21 is smaller than the dimension W31 in the W-axis direction of the first external electrode 21. As shown in FIG. 7B, the dimension L21 in the L-axis direction of the second connecting end surface 25c2 is smaller than the dimension W21 in the W-axis direction of the second connecting end surface 25c2. The dimension L41 in the L-axis direction of the second external electrode 22 is smaller than the dimension W41 in the W-axis direction of the second external electrode 22.

In one aspect of the invention, the area of the first connecting end surface 25c1 is 5% or more of the area of the first external electrode 21. With the area of the first connecting end surface 25c1 being 5% or more of the area of the first external electrode 21, the first connecting portion 25b1 and the first external electrode 21 can be firmly bonded together. The area of the first connecting end surface 25c1 may be 10% or more of the area of the first external electrode 21. With the area of the first connecting end surface 25c1 being 10% or more of the area of the first external electrode 21, the first connecting portion 25b1 and the first external electrode 21 can be more firmly bonded together.

In one aspect of the invention, the area of the second connecting end surface 25c2 is 5% or more of the area of the second external electrode 22. With the area of the second connecting end surface 25c2 being 5% or more of the area of the second external electrode 22, the second connecting portion 25b2 and the second external electrode 22 can be firmly bonded together. The area of the second connecting end surface 25c2 may be 10% or more of the area of the second external electrode 22. With the area of the second connecting end surface 25c2 being 10% or more of the area of the second external electrode 22, the second connecting portion 25b2 and the second external electrode 22 can be more firmly bonded together.

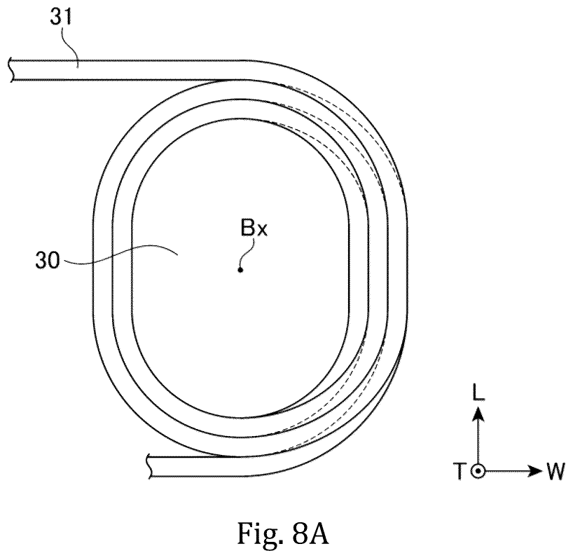

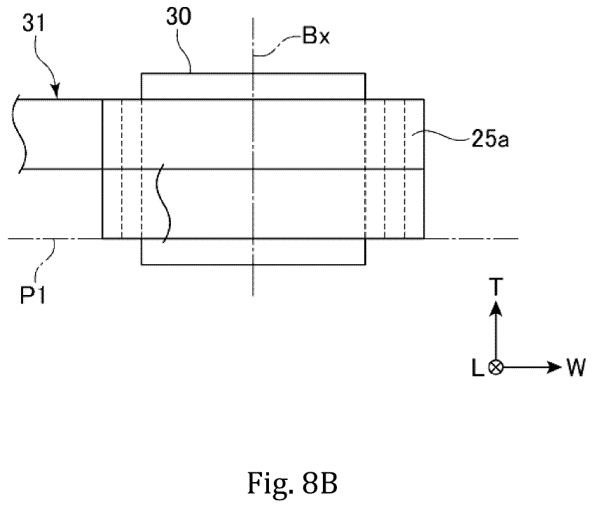

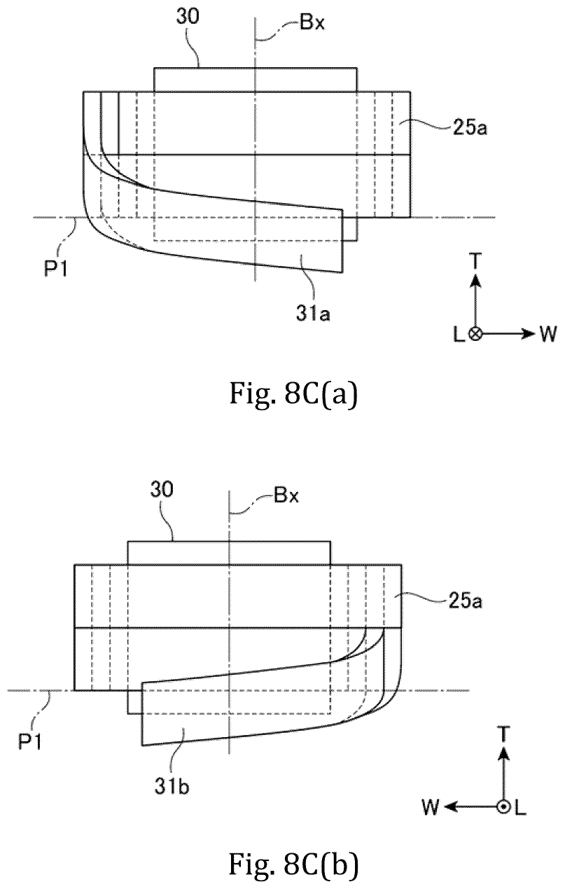

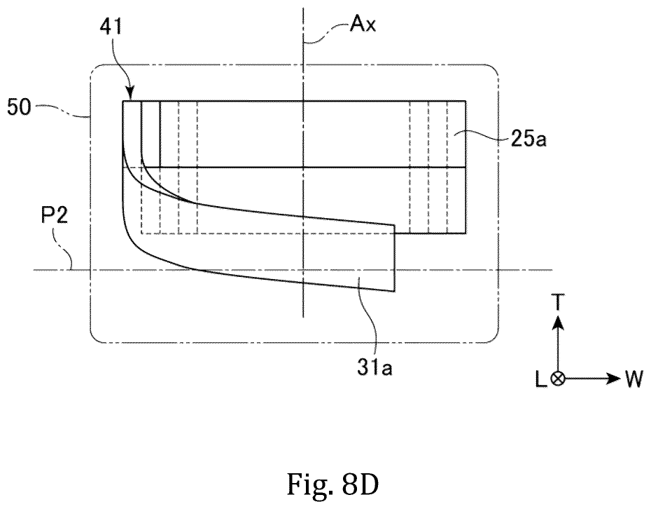

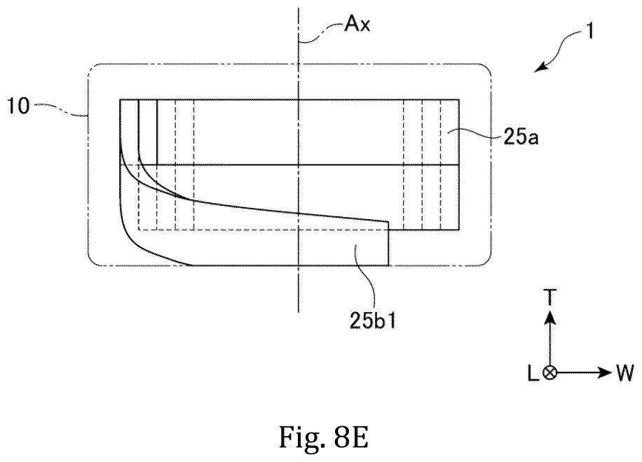

Next, a manufacturing method of the coil component 1 will be described with reference to FIGS. 8A to 8E. The coil conductor 25 may be produced by plastic deformation of a strip made of a conductive material using a coil winding machine. The coil winding machine used may be a commercially available spindle-type coil winding machine, a commercially available flyer-type coil winding machine, or other known coil winding machines.

First, with reference to FIGS. 8A to 8C (b), a description is given of an example of a method for producing the coil conductor 25 from a strip 31 made of a metal material having an excellent conductivity. As shown in FIG. 8A, the strip 31 is a long member. The strip 31 has, for example, a rectangular section.

In the coil winding machine, the strip 31, which is wound on a bobbin, is transported by a transport roller from the bobbin to a nozzle, and is fed by the nozzle to the vicinity of an arbor, which is a winding core. FIG. 8A shows an example of an arbor 30. FIG. 8A shows a section orthogonal to the rotation axis Bx of the arbor 30 (when the arbor 30 is stationary and the nozzle turns, the rotation axis Bx of the arbor 30 means the revolution axis of the nozzle. This holds true in the following description). The outer peripheral surface of the arbor 30 has a shape corresponding to the inner peripheral surface of the coil conductor 25. For example, the section of the arbor 30 shown in FIG. 8A is oval.

When a spindle-type coil winding machine is used, the arbor 30 is supported on the spindle such that it can rotate around the rotation axis Bx. The nozzle, which is not shown in the drawing, is configured to be movable in three axial directions in synchronization with or independently of the rotation of the arbor 30. To wind the strip 31 around the arbor 30, the nozzle is positioned appropriately relative to the arbor 30, and the arbor 30 is then rotated relative to the nozzle while tension is being applied to the strip 31 from the nozzle. This causes the strip 31 to be wound around the arbor 30 without loosening, forming a winding portion 25a around the arbor 30, as shown in FIG. 8B. In the embodiment shown, the winding portion 25a is wound around the arbor 30 to form two layers, upper and lower ones. The lower layer of the winding portion 25a is wound along a plane P1 orthogonal to the rotation axis Bx of the arbor 30.

At the time when winding of the winding portion 25a is ended, the nozzles are at positions corresponding to one end and the other end of the winding portion 25a. After winding of the winding portion 25a is ended, the nozzles are moved along the W-axis direction from one end and the other end of the winding portion 25a while downward tension is applied from the nozzles to the strip 31. As a result, the strip 31 is extended from each of the two ends of the winding portion 25a in a direction inclined downward with respect to the plane P1. Thus, as shown FIGS. 8C (a) and 8C (b), a part of the strip 31 forms a first inclined portion 31a and a second inclined portion 31b, the first inclined portion 31a extending from one end of the winding portion 25a in a direction inclined downward with respect to the plane P1, the second inclined portion 31b extending from the other end of the winding portion 25a in a direction inclined downward with respect to the plane P1. The magnitude of the tension applied downward from the nozzles to the strip 31 is adjusted so that the inclination of the first and second inclined portions 31a and 31b with respect to the plane P1 is 1 to 10°. Both the first and second inclined portions 31a and 31b are extended in a direction that is inclined not only with respect to the plane P1 but also with respect to the rotation axis Bx.

The strip 31 is then cut at the respective ends of the first and second inclined portions 31a and 31b to separate the workpiece 41 having the winding portion 25a wound around the arbor 30, the first inclined portion 31a, and the second inclined portion 31b. The workpiece 41 is then removed from the arbor 30, and the workpiece 41 removed from the arbor 30 is placed in a molding die.

Following this, a slurry obtained by mixing and kneading metal magnetic particles and a resin material is poured into the molding die where the coil conductor 25 is placed, and a molding pressure is applied to the slurry in the molding die, to produce a molded body 50 containing the workpiece 41, as shown in FIG. 8D. There are no particular restrictions on the magnetic and resin materials contained in the slurry, and any known magnetic and resin materials can be used. The molded body 50 is then heated to set the resin material, thereby obtaining a magnetic base body having the workpiece 41 placed inside. In the magnetic base body, the metal magnetic particles are bound together by the set resin.

The magnetic base body thus obtained is removed from the molding die, and the bottom surface of the magnetic base body removed from the molding die is subjected to surface treatment to expose the first and second inclined portions 31a and 31b from the bottom surface. In the surface treatment, the bottom surface of the magnetic base body is subjected to grinding with a grinding blade, polishing, laser processing, or chemical processing, such as acid treatment, to remove the underside of the magnetic base body to the cutting plane P2. The cutting plane P2 corresponds to the bottom surface 10b of the base body 10. When the underside of the base body 10 is removed to the cutting plane P2, the parts of the first and second inclined portions 31a and 31b that are below the cutting plane P2 are also removed. Through the surface treatment performed on the bottom surface of the base body 10 as described above, the magnetic base body forms the base body 10, the first inclined portion 31a is partly removed to form the first connecting portion 25b1, and the second inclined portion 31b is partly removed to form the second connecting portion 25b2. As shown in FIG. 8E and FIG. 4, the first connecting end surface 25c1 of the first connecting portion 25b1 and the second connecting end surface 25c2 of the second connecting portion 25b2 are exposed from the bottom surface 10b of the base body 10.

When the surface treatment for removing the underside of the magnetic base body to the cutting plane P2 is performed by laser processing, damage to the worked surface (i.e., the bottom surface 10b of the base body 10) can be controlled compared to cutting or polishing processes. In addition, when the surface treatment on the magnetic base body is performed by laser processing, dirt and oxides adhered to the first and second connecting end surfaces 25c1 and 25c2 can be removed, and thus the bonding strength can be increased between the first connecting portion 25b1 and the first external electrode 21 and between the second connecting portion 25b2 and the second external electrode 22. Further, when the surface treatment on the magnetic base body is performed by laser processing, the metal magnetic particles and resin present around the first and second connecting portions 25b 1 and 25b2 can be removed, so that the ends of the first and second connecting portions 25b1 and 25b2 can protrude from the bottom surface of the base body 10.

Following this, a conductive paste is applied to the surface of the base body 10 to form the first and second external electrodes 21 and 22. The first external electrode 21 is formed to cover the first connecting end surface 25c1 exposed from the bottom surface 10b of the base body 10, and the second external electrode 22 is formed to cover the second connecting end surface 25c2 exposed from the bottom surface 10b of the base body 10. The first and second external electrodes 21 and 22 may include a plating layer. There may be two or more plating layers. The two plating layers may include a Ni plating layer and a Sn plating layer externally provided on the Ni plating layer.

In the above-described manner, the coil component 1 is produced. The method of manufacturing the coil component 1 is not limited to the method described above. The coil component 1 may be produced, for example, by making a core made of magnetic material and winding the strip 31 around the core. The strip 31 is wound around the core in the same manner as when the strip 31 is wound around the arbor 30. Also, the base body 10 containing the coil conductor 25 may be produced by a thin-film process.

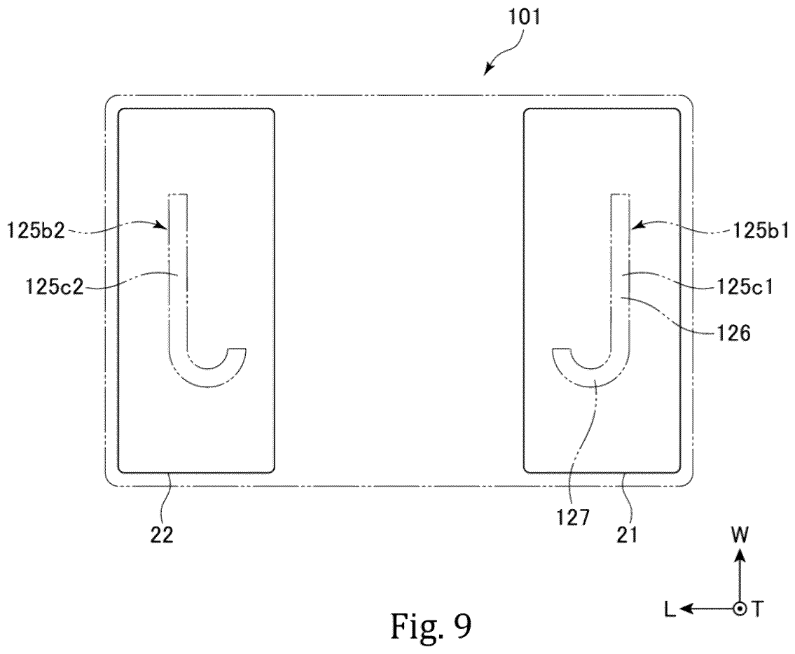

The following describes a coil component 101 according to another embodiment of the invention with reference to FIG. 9. FIG. 9 shows a bottom view of the coil component 101. The coil component 101 differs from the coil component 1 in that it includes a first connecting portion 125b1 instead of the first connecting portion 25b1 and a second connecting portion 125b2 instead of the second connecting portion 25b2. FIG. 9, shows the end surfaces of the first and second connecting portions 125b1 and 125b2 exposed from the base body 10, shown through the first and second external electrodes 21 and 22, respectively.

As shown in FIG. 9, the first connecting portion 125b1 is configured so that the first connecting end surface 125c1, which has a J-shape, is exposed from the bottom surface 10b of the base body 10. The first connecting end surface 125c1 includes a first straight region 126 extending along the W-axis direction and a curved region 127 extending from one end in the W-axis direction of the first straight region 126. The first connecting portion 125b1 extends from the end surface shown in FIG. 9 to the inside of the base body 10 along the T-axis direction. As with the first connecting portion 25b1, the first connecting portion 125b1 is configured so that the dimension in the T-axis direction of the section along a plane orthogonal to the W axis is larger than the dimension in the L-axis direction of the same section. The first connecting portion 125b1 has a shape that extends in the W-axis direction and curves inside the base body 10, and thus it can withstand loads applied to the base body 10 from various directions. As a result, the first connecting portion 125b1 can further improve the mechanical strength of the base body 10.

The second connecting portion 125b2 is configured so that the second connecting end surface 125c2, which has an inverted J-shape, is exposed from the bottom surface 10b of the base body 10. As with the first connecting end surface 125c1, the second connecting end surface 125c2 includes a straight region extending along the W-axis direction and a curved region extending from one end in the W-axis direction of the straight region. As with the first connecting portion 125b 1, the second connecting portion 125b2 is configured so that the dimension in the T-axis direction of the section along a plane orthogonal to the W axis is larger than the dimension in the L-axis direction of the same section. As a result, the second connecting portion 125b2 can further improve the mechanical strength of the base body 10.

Since the contact area between the first connecting portion 125b1 and the first external electrode 21 is larger than the contact area between the first connecting portion 25b1 and the first external electrode 21 by the area of the curved region 127, the first external electrode 21 is more firmly bonded to the first connecting portion 125b1. Similarly, the second external electrode 22 is more firmly bonded to the second connecting portion 125b2, because of the contact area with the second connecting portion 125b2 being larger by the area of the curved region.

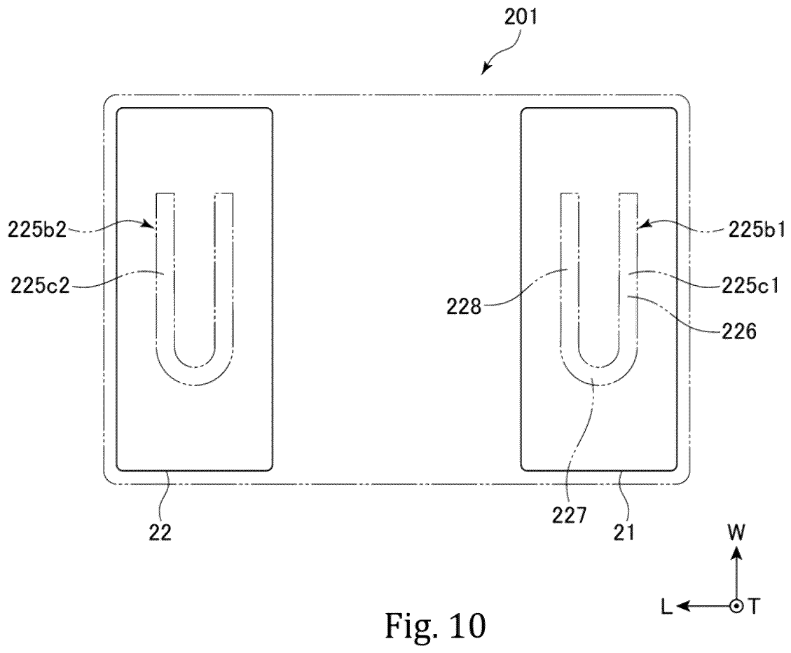

The following describes a coil component 201 according to another embodiment of the invention with reference to FIG. 10. FIG. 10 shows a bottom view of the coil component 201. The coil component 201 differs from the coil component 1 in that it includes a first connecting portion 225b1 instead of the first connecting portion 25b1 and a second connecting portion 225b2 instead of the second connecting portion 25b2. FIG. 10, shows the end surfaces of the first and second connecting portions 225b1 and 225b2 exposed from the base body 10, shown through the first and second external electrodes 21 and 22, respectively.

As shown in FIG. 10, the first connecting portion 225b1 is configured so that the first connecting end surface 225c1, which has a U-shape, is exposed from the bottom surface 10b of the base body 10. The first connecting end surface 225c1 includes a first straight region 226 extending along the W-axis direction, a curved region 227 extending from one end in the W-axis direction of the first straight region 226, and a second straight region 228 extending along the W-axis direction. The first straight region 226 is connected to one end of the curved region 227, and the second straight region 228 is connected to the other end of the curved region 227. The first connecting portion 225b1 extends from the first connecting end surface 225c1 shown in FIG. 10 to the inside of the base body 10 along the T-axis direction. As with the first connecting portion 25b1, the first connecting portion 225b1 is configured so that the dimension in the T-axis direction of the section along a plane orthogonal to the W axis is larger than the dimension in the L-axis direction of the same section. The first connecting portion 225b1 has a shape that extends in the W-axis direction and curves inside the base body 10, and thus it can withstand loads applied to the base body 10 from various directions. As a result, the first connecting portion 225b1 can further improve the mechanical strength of the base body 10.

The second connecting portion 225b2 is configured so that the second connecting end surface 225c2, which has a U-shape, is exposed from the bottom surface 10b of the base body 10. The second connecting end surface 225c2 has a U-shape, similarly to the first connecting end face 225C1. As with the first connecting portion 225b1, the second connecting portion 225b2 is configured so that the dimension in the T-axis direction of the section along a plane orthogonal to the W axis is larger than the dimension in the L-axis direction of the same section. As a result, the second connecting portion 225b2 can further improve the mechanical strength of the base body 10.

Since the contact area between the first connecting portion 225b1 and the first external electrode 21 is larger than the contact area between the first connecting portion 25b1 and the first external electrode 21 by the areas of the curved region 227 and the second straight region 228, the first external electrode 21 is more firmly bonded to the first connecting portion 225b1. Similarly, the second external electrode 22 is more firmly bonded to the second connecting portion 225b2, because of the contact area with the second connecting portion 225b2 being larger by the areas of the curved region and the second straight region.

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A coil component comprising:
a base body (10) having a first surface (10b);
a coil conductor (25) provided in the base body, the coil conductor being made of a conductive material;
a first external electrode (21) provided on the first surface of the base body; and
a second external electrode (22) provided on the first surface of the base body, the second external electrode being spaced apart from the first external electrode in a first direction (L) extending along the first surface,
wherein the coil conductor includes a winding portion (25a) extending along a circumferential direction around a coil axis, a first connecting portion (25b1) connecting between one end of the winding portion and the first external electrode, and a second connecting portion (25b2) connecting between another end of the winding portion and the second external electrode,
wherein when viewed from a direction perpendicular to the first surface, the first connecting portion extends along a second direction (W) orthogonal to the first direction, and
wherein the first connecting portion has a first section along a cutting plane orthogonal to the second direction, and a dimension (T1) of the first section in a third direction (T) orthogonal to the first direction is larger than a dimension (L1) of the first section in the first direction.

### Additional Embodiment 2

The coil component of Additional Embodiment 1, wherein the first connecting portion has a first end surface (25c1) exposed from the first surface of the base body, and the first connecting portion is connected to the first external electrode at the first end surface.

### Additional Embodiment 3

The coil component of Additional Embodiment 2,
wherein the coil conductor is made of a strip having a rectangular section, and
wherein a first area representing an area of the first end surface is larger than a second area representing a sectional area of the strip.

### Additional Embodiment 4

The coil component of Additional Embodiment 3, wherein the first area is two or more times as large as the second area.

### Additional Embodiment 5

The coil component of any one of Additional Embodiments 2 to 4, wherein the first end surface of the first connecting portion extends in the first direction to intersect a first center line (CL11) passing through a center of the first external electrode in the first direction.

### Additional Embodiment 6

The coil component of any one of Additional Embodiments 2 to 5, wherein the first end surface of the first connecting portion extends in the second direction to intersect a second center line (CL12) passing through a center of the first external electrode in the second direction.

### Additional Embodiment 7

The coil component of any one of Additional Embodiments 2 to 6, wherein a dimension (L11) of the first end surface of the first connecting portion in the first direction is smaller than a dimension (W11) of the first end surface of the first connecting portion in the second direction.

### Additional Embodiment 8

The coil component of Additional Embodiment 7, wherein a dimension (L31) of the first external electrode in the first direction is smaller than a dimension (W31) of the first external electrode in the second direction.

### Additional Embodiment 9

The coil component of any one of Additional Embodiments 2 to 8, wherein the first end surface includes a first straight region extending along the second direction and a curved region extending from one end in the second direction of the first straight region.

### Additional Embodiment 10

The coil component of Additional Embodiment 9,
wherein the first end surface further includes a second straight region extending along the second direction, and
wherein the first straight region is connected to one end of the curved region, and the second straight region is connected to another end of the curved region.

### Additional Embodiment 11

The coil component of any one of Additional Embodiments 1 to 10, wherein the first connecting portion is inclined with respect to the first surface.

### Additional Embodiment 12

The coil component of any one of Additional Embodiments 1 to 11, wherein the base body contains a plurality of metal magnetic particles.

### Additional Embodiment 13

The coil component of Additional Embodiment 12,
wherein the base body further contains a binder, and
wherein the plurality of metal magnetic particles are bound together by the binder.

### Additional Embodiment 14

The coil component of any one of Additional Embodiments 1 to 13, wherein the first external electrode and the second external electrode are in contact with only the first surface of the base body.

### Additional Embodiment 15

The coil component of any one of Additional Embodiments 1 to 14, wherein the coil axis extends in a direction orthogonal to the first surface.

What is claimed is:

1. A coil component comprising:
a base body having a first surface;
a coil conductor provided in the base body, the coil conductor being made of a conductive material;
a first external electrode provided on the first surface of the base body; and
a second external electrode provided on the first surface of the base body, the second external electrode being spaced apart from the first external electrode in a first direction extending along the first surface,
wherein the coil conductor includes a winding portion extending along a circumferential direction around a coil axis, a first connecting portion connecting between one end of the winding portion and the first external electrode, and a second connecting portion connecting between another end of the winding portion and the second external electrode,
wherein when viewed from a direction perpendicular to the first surface, the first connecting portion extends along a second direction orthogonal to the first direction, and
wherein the first connecting portion has a first section along a cutting plane orthogonal to the second direction, and a dimension of the first section in a third direction orthogonal to the first direction is larger than a dimension of the first section in the first direction.

2. The coil component of claim 1, wherein the first connecting portion has a first end surface exposed from the first surface of the base body, and the first connecting portion is connected to the first external electrode at the first end surface.

3. The coil component of claim 2,
wherein the coil conductor is formed from a strip having a rectangular section, and
wherein a first area representing an area of the first end surface is larger than a second area representing a sectional area of the strip.

4. The coil component of claim 3, wherein the first area is two or more times as large as the second area.

5. The coil component of claim 2, wherein the first end surface of the first connecting portion extends in the first direction to intersect a first center line passing through a center of the first external electrode in the first direction.

6. The coil component of claim 2, wherein the first end surface of the first connecting portion extends in the second direction to intersect a second center line passing through a center of the first external electrode in the second direction.

7. The coil component of claim 2, wherein a dimension of the first end surface of the first connecting portion in the first direction is smaller than a dimension of the first end surface of the first connecting portion in the second direction.

8. The coil component of claim 7, wherein a dimension of the first external electrode in the first direction is smaller than a dimension of the first external electrode in the second direction.

9. The coil component of claim 2, wherein the first end surface includes a first straight region extending along the second direction and a curved region extending from one end in the second direction of the first straight region.

10. The coil component of claim 9,
wherein the first end surface further includes a second straight region extending along the second direction, and
wherein the first straight region is connected to one end of the curved region, and the second straight region is connected to another end of the curved region.

11. The coil component of claim 1, wherein the first connecting portion is inclined with respect to the first surface.

12. The coil component of claim 1, wherein the base body contains a plurality of metal magnetic particles.

13. The coil component of claim 12,
wherein the base body further contains a binder, and
wherein the plurality of metal magnetic particles are bound together by the binder.

14. The coil component of claim 1, wherein the first external electrode and the second external electrode are in contact with only the first surface of the base body.

15. The coil component of claim 1, wherein the coil axis extends in a direction orthogonal to the first surface.
